(19) United States
(12) Patent Application Publication
(10) Pub. No.: US 2022/0213373 A1
(43) Pub. Date: Jul. 7, 2022

(54) HEAT-REMOVING SHEET

(71) Applicant: 3M INNOVATIVE PROPERTIES COMPANY, St. Paul, MN (US)

(72) Inventors: Evan Koon Lun Yuuji Hajime, Woodbury, MN (US); Brandon A. Bartling, Woodbury, MN (US); Jason D. Clapper, Lino Lakes, MN (US)

(21) Appl. No.: 17/609,214

(22) PCT Filed: Jun. 2, 2020
(86) PCT No.: PCT/IB2020/055205

§ 371 Date: Nov. 5, 2021

Related U.S. Application Data
(60) Provisional application No. 62/859,399, filed on Jun. 10, 2019.

(51) Int. Cl. C09K 5/18; C08K 3/34; C08J 5/18; H01M 10/6551; H01M 10/651; H01M 10/613

(52) U.S. Cl. CPC C09K 5/18; C08K 3/34; C08J 5/18; H01M 10/6551; C08J 2383/04; H01M 10/613; C08K 2003/343; C08J 2375/14; H01M 10/651

(57) ABSTRACT

A heat-removing sheet includes a plurality of endothermic particles and a chemically cured or radiation cured resin binding the endothermic particles together. The heat-removing sheet includes the endothermic particles at greater than 60 weight percent, has a flexural modulus of less than 3000 MPa and a flexural strength of greater than 0.15 MPa. The heat-removing sheet is a single free-standing layer.

### BACKGROUND

A coating may include a thermally active material dispersed in a binder.

### SUMMARY

In some aspects of the present description, a heat-removing sheet including a plurality of endothermic particles and a chemically cured or radiation cured resin binding the endothermic particles together is provided. The heat-removing sheet includes the endothermic particles at greater than 60 weight percent, has a flexural modulus of less than 3000 MPa and a flexural strength of greater than 0.15 MPa. The heat-removing sheet is a single free-standing layer.

### BRIEF DESCRIPTION OF THE DRAWINGS

FIG. 1 is a schematic cross-sectional view of a heat-removing sheet;

FIG. 2 is a schematic cross-sectional view of a heat-removing sheet bent to a radius of curvature R;

FIG. 3 is a schematic plot of the heat absorption rate of a heat-removing sheet;

FIG. 4 is a schematic cross-sectional view of a battery; and

FIGS. 5-6 are plots of heat flow rates for heat-removing sheets.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Conventional heat-removing sheets typically include a coating on a substrate layer where the coating includes endothermic particles. In some applications described herein, it is preferred that a heat-removing sheet have a high heat absorption rate per unit mass of the heat-removing sheet (e.g., at least 1.5 W/g, or at least 1.8 W/g, or at least 2 W/g for at least one temperature in a range of 60° C. to 170° C.). A substrate layer reduces the heat absorption rate per unit mass due to the mass of the substrate. According to some embodiments of the present description it has been found that a heat-removing sheet can be provided as a single free-standing layer that has desired mechanical properties and a high heat absorption rate per unit mass. A free-standing layer does not need a separate substrate to maintain structural integrity.

The heat-absorbing sheets of the present description may be used in battery applications to remove heat from a battery cell during a thermal runaway event (e.g., as has been known to occur in some lithium ion batteries). The endothermic material used in the heat-absorbing sheet may be selected to absorb heat at lower temperatures than in conventional fire protection coatings. For example, the heat-absorbing sheet may have an endothermic peak temperature in a range of 60° C. to 170° C., or 70° C. to 150° C. and/or may have an onset temperature for the endotherm in a range of 60° C. to 120° C., or 70° C. to 110° C.

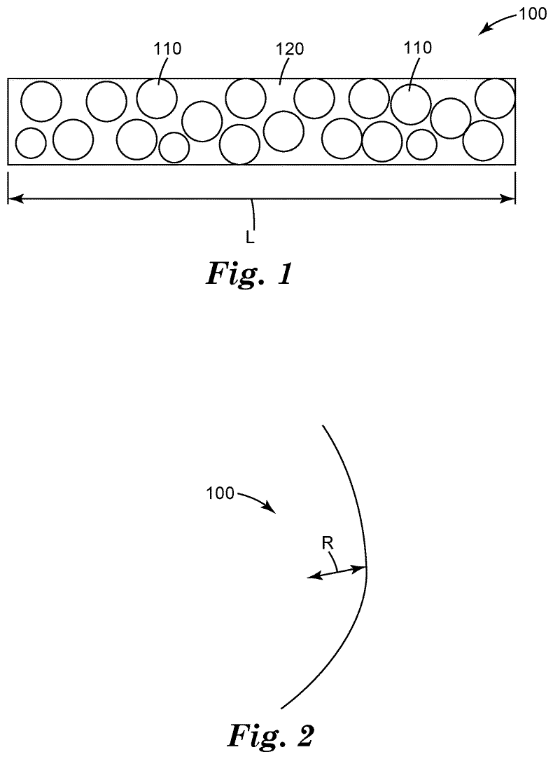

FIG. 1 is a schematic cross-sectional view of a heat-removing sheet 100 that includes a plurality of endothermic particles 110 and a chemically cured or radiation cured resin 120 binding the endothermic particles together. In some embodiments, the heat-removing sheet 100 includes the endothermic particles 110 at greater than 60 weight percent, or greater than 70 weight percent, or greater than 80 weight percent, or greater than 85 weight percent. Here, the weight percent is based on the total weight of the heat-removing sheet 100. In some embodiments, the heat-removing sheet 100 includes the endothermic particles 110 at greater than 55 volume percent, or greater than 60 volume percent, or greater than 65 volume percent. Here, the volume percent is based on the total volume of the heat-removing sheet 100 (e.g., length times width times an average thickness of the sheet). In some embodiments, the heat-removing sheet 100 consists essentially of the chemically cured or radiation cured resin 120 and the endothermic particles 110. For example, the heat-removing sheet 100 may include less than 1 wt. %, or less than 0.5 wt. % of any other components. In other words, the heat-removing sheet 100 may include the chemically cured or radiation cured resin 120 and the endothermic particles 110 at no less than 99 or 99.5 percent by weight of the heat-removing sheet 100.

The heat-removing sheet 100 is a single free-standing layer. The terms “free-standing” or “self-supporting” refers to a film, sheet or layer of material having sufficient structural integrity such that it is capable of being handled and/or subjected to standard manufacturing processes without a separate supporting layer. A single layer does not include any interface between different layers. If an additional element or layer were placed on the heart-removing sheet 100, the combination of the additional element or layer and the heat-removing sheet 100 would not be a single layer, but the heat-removing sheet 100 that would be in contact with the additional element or layer would still be a single free-stranding layer. In some embodiments, the heat-removing sheet 100 is provided as a single free-standing layer that is not bonded to any other free-standing layer.

In some embodiments, the heat-removing sheet 100 has an average thickness in a range of 1 to 10 mm, or 2 to 8 mm, for example.

In some embodiments, the particles 110 are dispersed in the resin 120. For example, the particles may be dispersed in an uncured resin which is subsequently cured in a mold to form a sheet. In some embodiments, the particles may be coated with resin and the coated particles bound together through the resin coating, for example.

In some embodiments, the chemically cured or radiation cured resin 120 is formed from free radical polymerizable monomers. In some embodiments, suitable free radical polymerizable monomers include monofunctional acrylates or methacrylates. Suitable monofunctional (meth)acrylates could include n-butyl (meth)acrylate, tert-butyl (meth)acrylate, 2-ethylhexyl (methacrylate), 2-hydroxyethyl(meth)acrylate, cyclohexyl(meth)acrylate, isobornyl(meth)acrylate, methoxy poly(ethylene glycol) (meth)acrylate, poly(ethylene glycol) (meth)acrylate.

In some embodiments, the free radical polymerizable monomers may include vinyl monomers such as styrene, n-vinyl 2-pyrrolidinone, N,N dimethyl acrylamide, acrylamide, N-vinyl caprolactam, and tri allyl-1,3,5-triazine-2,3,4-trione for example.

In some embodiments, the free radical polymerizable resin may include multifunctional (meth)acrylates. Examples of multifunctional (meth)acrylates include 1,3-butylene glycol diacrylate, 1,4-butanedioldiacrylate, poly(ethylene glycol) di(meth)acrylate, ethoxylated bisphenol A di(meth)acrylate, triethylene glycol di(meth)acrylate, tetraethylene glycol di(meth)acrylate, trimethyloyl propane tri(meth)acrylate, and 1,6-hexanediol di(meth)acrylate, and ethoxylated pentaerythritol tetra(meth)acrylate. In some embodiments, the chemically cured or radiation cured resin 120 is or includes radical cured resin such as ultraviolet (UV) cured acrylate. Suitable radical cured resins include UV cured aliphatic urethane acrylates. Suitable aliphatic urethane acrylates include EBECRYL 230 (available from Allnex, Frankfurt am Main, Germany), UX-0937 from Nippon Kayaku, Tokyo, Japan, and CN9009 (available from Sartomer USA, Exton, Pa.), for example.

In some embodiments the free radically polymerizable resin may further include chain transfer agents to control the molecular weight and crosslinking density of the resultant binder. Examples of useful chain transfer agents include but are not limited to those selected from the group consisting of carbon tetrabromide, alcohols, mercaptans, and mixtures thereof. Examples of useful chain transfer agents include 1,4-bis(3-mercaptobutylyloxy)butane) and Pentaerithrytol tetrakis (3-mercaptobutylate).

In some embodiments, the free radically polymerizable resin may further includes a UV radical initiator or photoinitiator. Example photoinitiators are those available under the trade designations IRGACURE and DAROCUR from Ciba Speciality Chemical Corp., Tarrytown, N.Y. and include 1-hydroxy cyclohexyl phenyl ketone (IRGACURE 184), 2,2-dimethoxy-1,2-diphenylethan-1-one (IRGACURE 651), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173) and 2,4,6-trimethylbenzoylphenyl phosphinate.

In some embodiments, the chemically cured or radiation cured resin 120 is or includes chemically cured silicone or chemically cured epoxy. Suitable chemically cured silicones include those prepared from two-part, Pt-catalyzed silicones (e.g., 3M IMPRINT 3 VPS Impression Material available from 3M Company, St., Paul, Minn.), or one-part moisture-cure silicone (e.g., RTV Silicone available from CRC Industries, Horsham Township, Pa.), for example. Suitable chemically cured epoxies include those prepared from two part epoxy adhesive systems such those available from 3M Company under the SCOTCH-WELD tradename (e.g., 3M Scotch-Weld Epoxy Adhesive DP100).

FIG. 2 is a schematic cross-sectional view showing the heat-removing sheet 100 bent to a radius of curvature R. The radius of curvature is the inner radius of the bent sheet. For example, the heat-removing sheet 100 may be bent around a cylindrical mandrel having a radius R (e.g., bent 180 degrees around the mandrel or bent along only a portion of the mandrel when a length of the sample is less than πR). In some embodiments, the heat-removing sheet 100 can be bent to an inner radius of curvature of less than 50 cm, or less than 30 cm, or less than 20 cm, or less than 10 cm, or less than 5 cm, or less than 2 cm, or less than 1 cm, or less than 0.5 cm without yielding or cracking. Typically, thinner sheets (e.g., 1-4 mm thick) can be bent to a tighter radius of curvature than thicker sheets (e.g., 6-10 mm thick) without yielding or cracking. Yielding refers to non-recoverable plastic deformation strain of at least 0.2%. Alternatively, or in addition, the bendability of the heat-removing sheet can be characterized by a degree of curvature (central angle subtended by sheet when it is bent into a cylindrical arc) that the sheet can be bent to without yielding or cracking. In some embodiments, the heat-removing sheet can be bent to a degree of curvature of at least at least 8 degrees, or at least 10 degrees, or at least 12 degrees, or at least 15 degrees, or at least 20 degrees, or at least 25 degrees, or at least 30 degrees without yielding or cracking. In some such embodiments, the heat-removing sheet has a length of less than 50 cm, or less than 30 cm, or less than 20 cm, or less than 10 cm and the degree of curvature is determined by bending the sheet into a cylindrical arc with the length of the sheet along the circumference of the arc.

In some embodiments, the heat-removing sheet has a flexural modulus of less than 3000 MPa and a flexural strength of greater than 0.15 MPa. In some such embodiments, the flexural modulus is less than 1000 MPa, or less than 500 MPa, or less than 300 MPa, or less than 200 MPa. In some such embodiments or in other embodiments, the flexural strength is greater than 0.2 MPa, or greater than 0.3 MPa, or greater than 0.5 MPa, or greater than 1 MPa, or greater than 2 MPa, or greater than 3 MPa. In some embodiments, the heat-removing sheet 100 has a flexural modulus of less than 300 MPa, or less than 200 MPa, or less than 100 MPa, and has a flexural strength of greater than 0.3 MPa. In some embodiments, the heat-removing sheet 100 has a flexural modulus of less than 50 MPa and a flexural strength of greater than 0.4 MPa. In some embodiments, the flexural modulus can be as low as 1 MPa, or 3 MPa, or 5 MPa, or 10 MPa, for example. In some embodiments, the flexural strength can be as high as 20 MPa, or 10 MPa, or 5 MPa, or 4 MPa, or 3.5 MPa for example.

Flexural modulus and flexural strength can be determined using a 3 point bend test according to the ASTM D790-17 test standard “Standard Test Methods for Flexural Properties of Unreinforced and Reinforced Plastics and Electrical Insulating Materials”. As described further in the Examples, in this test, the flexural strength is the maximum flexural stress sustained by the test specimen during the bending test, and the flexural modulus is the tangent modulus of elasticity (ratio of stress to corresponding strain in the elastic limit) determined in the bending test.

In some embodiments, the plurality of endothermic particles 110 includes at least one of a hydrate (e.g., an inorganic hydrate) or a carbonate. In some embodiments, the plurality of endothermic particles 110 is selected from the group consisting of magnesium chloride hexahydrate, magnesium sulfate heptahydrate, sodium tetraborate decahydrate, trisodium phosphate dodecahydrate, disodium hydrogen phosphate heptahydrate, aluminum sulfate octadecahydrate, calcium sulfate dihydrate, sodium metasilicate pentahydrate, aluminum trihydrate, sodium bicarbonate, magnesium carbonate trihydrate, magnesium carbonate pentahydrate, copper sulfate pentahydrate, zinc nitrate hexahydrate, sodium tetraborate decahydrate, sodium acetate trihydrate, zinc sulfate heptahydrate, aluminum chloride hexahydrate, potassium aluminum sulfate dodecahydrate, calcium chloride hexahydrate, ammonium oxalate monohydrate, boric acid, and combinations thereof. The particles 110 may have any suitable distribution of sizes (e.g., monomodal or polymodal) and any suitable mean (e.g., D₅₀) particle size (e.g., 1 micrometer to 10 mm, or 10 micrometers to 5 mm, or 100 micrometers to 2 mm). The types of particles 110 used may be selected to provide an endothermic peak temperature in a desired temperature range.

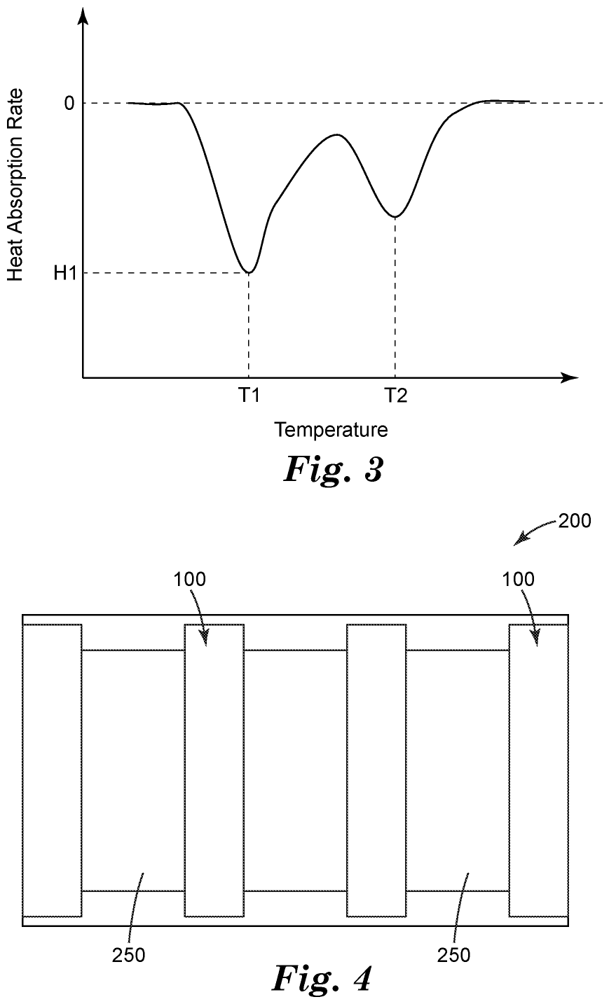

FIG. 3 is a schematic plot of the heat absorption rate of a heat-removing sheet, such as heat-removing sheet 100, versus temperature. The heat absorption rate can be determined using differential scanning calorimetry (DSC). In some cases, the DSC heat absorption curve is determined by keeping a sample at 0° C. for 5 minutes and then ramping up to 300° C. at a heating rate of 10° C./min. In some embodiments, the plurality of endothermic particles 110 has an endothermic peak temperature T1 in a range of 60° C. to 170° C., or 70° C. to 150° C. In some such embodiments, the plurality of endothermic particles has one or more additional endothermic peak temperature. For example, a second endothermic peak temperature T2 higher than T1 is schematically illustrated in FIG. 3. In some embodiments, the heat-removing sheet 100 has a heat absorption rate (e.g., H1) of at least 1.5 W/g, or at least 1.8 W/g, or at least 2 W/g for at least one temperature in a range of 60° C. to 170° C. In some embodiments, the heat absorption rate is at least 1.5 W/g, or at least 1.8 W/g, or at least 2 W/g for at least one temperature in a range of 70° C. to 150° C. The area under the heat absorption rate curve is proportional to the total heat absorbed during the temperature ramp up. In some embodiments, the heat-removing sheet 100 absorbs at least 600 J/g, or at least 700 J/g, or at least 800 J/g when heated from 20° C. to 240° C. at a rate of 10° C./min.

In some embodiments, a battery includes a battery cell and the heat-removing sheet 100 disposed adjacent the battery cell. The battery may include one or more battery cells and a plurality of the heat-removing sheets 100.

FIG. 4 is a schematic cross-sectional view of a battery 200 including a plurality of battery cells 250 and a plurality of heat-removing sheets 100. In some embodiments, each battery cell 250 is disposed adjacent at least one (two in the illustrated embodiment) heat-removing sheet 100. Other arrangements of battery cells known in the art may be utilized. Each of the heat-removing sheets 100 in the battery 200 is a single free-standing layer, preferably having a high heat absorption rate per unit mass of the heat-removing sheet (e.g., at least 1.5 W/g, or at least 1.8 W/g, or at least 2 W/g for at least one temperature in a range of 60° C. to 170° C.). In some embodiments, a battery includes a heat-removing sheet 100 disposed between two battery cells where a major surface of the heat-removing sheet 100 is in direct contact with each battery cell. The heat-removing sheet 100 is preferably flexible (e.g., having a flexural modulus in a range described elsewhere) so that adjacent battery cells can swell without damaging the heat-removing sheet 100.

The following is a list of exemplary embodiments of the present description.

In a first embodiment, a heat-removing sheet comprises:

a plurality of endothermic particles; and

a chemically cured or radiation cured resin binding the endothermic particles together, wherein the heat-removing sheet includes the endothermic particles at greater than 60 weight percent, has a flexural modulus of less than 3000 MPa and a flexural strength of greater than 0.15 MPa, and wherein the heat-removing sheet is a single free-standing layer.

A second embodiment is the heat-removing sheet of the first embodiment, wherein the heat-removing sheet consists essentially of the chemically cured or radiation cured resin and the endothermic particles.

A third embodiment is the heat-removing sheet of the first or second embodiments, wherein the heat-removing sheet includes the endothermic particles at greater than 70 weight percent, or greater than 80 weight percent, or greater than 85 weight percent.

A fourth embodiment is the heat-removing sheet of any one of the first through third embodiments, wherein the heat-removing sheet includes the endothermic particles at greater than 55 volume percent, or greater than 60 volume percent, or greater than 65 volume percent.

A fifth embodiment is the heat-removing sheet of any one of the first through fourth embodiments having a flexural modulus of less than 1000 MPa, or less than 500 MPa, or less than 300 MPa, or less than 200 MPa.

A sixth embodiment is the heat-removing sheet of any one of the first through fifth embodiments having a flexural strength of greater than 0.2 MPa, or greater than 0.3 MPa, or greater than 0.5 MPa, or greater than 1 MPa, or greater than 2 MPa, or greater than 3 MPa.

A seventh embodiment is the heat-removing sheet of any one of the first through fourth embodiments having a flexural modulus of less than 300 MPa, or less than 200 MPa, or less than 100 MPa, and a flexural strength of greater than 0.3 MPa.

An eight embodiment is the heat-removing sheet of any one of the first through seventh embodiments, wherein the heat-removing sheet can be bent to an inner radius of curvature of less than 50 cm, or less than 30 cm, or less than 20 cm, or less than 10 cm, or less than 5 cm, or less than 2 cm, or less than 0.5 cm without yielding or cracking.

A ninth embodiment is the heat-removing sheet of any one of the first through eighth embodiments, wherein the plurality of endothermic particles has an endothermic peak temperature in a range of 60° C. to 170° C., or 70° C. to 150° C.

A tenth embodiment is the heat-removing sheet of any one of the first through ninth embodiments, wherein the heat-removing sheet has a heat absorption rate of at least 1.5 W/g, or at least 1.8 W/g, or at least 2 W/g for at least one temperature in a range of 60° C. to 170° C.

An eleventh embodiment is the heat-removing sheet of any one of the first through tenth embodiments, wherein the heat-removing sheet absorbs at least 600 J/g, or at least 700 J/g, or at least 800 J/g when heated from 20° C. to 240° C. at a rate of 10° C./min.

A twelfth embodiment is the heat-removing sheet of any one of the first through eleventh embodiments, wherein the chemically cured or radiation cured resin comprises ultraviolet (UV) cured acrylate.

A thirteenth embodiment is the heat-removing sheet of any one of the first through eleventh embodiments, wherein the chemically cured or radiation cured resin comprises chemically cured silicone.

A fourteenth embodiment is the heat-removing sheet of any one of the first through thirteenth embodiments, wherein the plurality of endothermic particles comprises at least one of a hydrate or a carbonate.

A fifteenth embodiment is a battery comprising a battery cell and the heat-removing sheet of any one of the first through fourteenth embodiments disposed adjacent the battery cell.

### EXAMPLES

Materials Used in the Examples

| Abbreviation | Description and Source |
|---|---|
| Metso 20 | Sodium metasilicate pentahydrate, obtained under the |
| | trade designation “METSO PENTABEAD 20” from PQ |
| | Corporation, Valley Forge, PA |
| Imp3LB | Two-part, Pt-catalyzed silicone, obtained under the trade |
| | designation “3M ESPE IMPRINT 3 LIGHT BODY” from |
| | 3M Company, St. Paul, MN |
| RTV | One-part, moisture-cured silicone, “RTV Silicone Sealant- |
| | Red” (Product #14059) from CRC Industries, Inc., |
| | Warminster, PA |
| E230 | Aliphatic urethane diacrylate, obtained under the trade |
| | designation “EBECRYL 230” from Allnex, Frankfurt, |
| | Germany |
| HEA | 2-Hydroxyethyl Acrylate, from BASF, Ludwigshafen, |
| | Germany |
| UX-0937 | Aliphatic urethane acrylate oligomer, obtained under the |
| | trade designation “UX-0937” from Nippon Kayaku, |
| | Tokyo, Japan |
| TEGDA | Triethyleneglycol Diacrylate, from Aldrich, Milwaukee, |
| | WI |
| SR494 | Ethoxylated pentaerythritol tetraacrylate, obtained under |
| | the trade designation “SR494” from Sartomer (Arkema |
| | Group), Colombes, France |
| t-BA | Tert-butyl acrylate, from Alfa Aesar, Haverhil, MA |
| CN9009 | Aliphatic urethane acrylate oligomer, obtained under the |
| | trade designation “CN9009” from Sartomer (Arkema |
| | Group), Colombes, France |
| BD1 | 1,4-bis(3-mercaptobutylyloxy)butane) from Showa |
| | Denko, Tokyo, Japan |
| PE1 | Pentaerithrytol tetrakis (3-mercaptobutylate) from Show |
| | Denko, Tokyo, Japan |
| TIC | Tri allyl-1,3,5-triazine-2,3,4-trione, from Aldrich, |
| | Milwaukee, WI |
| I-651 | 2,2-Dimethyoxy-1,2,-diphenylethan-1-one, obtained |
| | under the trade designation “IRGACURE-651” from |
| | BASF, Ludwigshafen, Germany |
| TPO-L | 2,4,6-trimethylbenzoylphenyl phosphinate, obtained under |
| | the trade designation “IRGACURE TPO-L” from BASF, |
| | Ludwigshafen, Germany |

### Test Methods

Differential Scanning Calorimetry (DSC)

Differential scanning calorimetry analysis was performed on samples using a TA Instruments Model Q200 differential scanning calorimeter (TA Instruments, New Castle, Del.). The sample (typically 2-10 mg) was placed in an aluminum pan (obtained under the trade designation “TZERO” from TA Instruments, New Castle, Del.) without a lid, and an empty aluminum pan without a lid was used as the reference. The sample and reference were initially cooled to 0° C. and kept at this temperature for 5 mins to equilibrate prior to ramping to 300° C. at a heating rate of 10° C./min. Measurements of heat flow versus temperature were plotted to determine the heat absorbing properties of a sample. Integration over a selected temperature range in the heat flow versus temperature curves (peaks in the negative direction of heat flow) was performed using TA INSTRUMENTS UNIVERSAL ANALYSIS 2000 software from TA Instruments, New Castle, Del., providing a measure of the amount of heat absorbed by the sample over the selected temperature range.

Flexural Strength and Flexural Modulus: Texture Analyzer

Flexural strength and flexural modulus measurements were made using a TA.XT Plus texture analyzer (Texture Technologies, Hamilton, Mass.) with the 3 point bend rig (Model TA-92N from Texture Technologies, Hamilton, Mass.). The support span was set at 50 mm and the rectangular sample was placed centered across the span. An about 3.0 mm radiused stainless steel flat probe was centered in the middle of the support span (above the sample) and compressed onto the sample at a test speed of 1.2 mm/min until the sample was broken or permanently deformed was used for all tests. Applied force and probe distance traveled were recorded to generate a load-deflection curve for each sample using EXPONENT software from Stable Micro Systems, Surrey, United Kingdom. The same software was used for Typical dimensions of tested samples were 2-3 mm×12-13 mm×˜75-76 mm.

Flexural strength (σ_{f} in MPa (psi)) was calculated at the maximum load point on the load-deflection curve using the following equation (Eqn. 3 for Flexural Stress from ASTM D790-17):

$${σ}_{f} = \frac{3 PL}{2 {bd}^{2}}$$

where:
P=load at a given point on the load-deflection, curve, N (lbf)
L=support span, mm (in.)
b=width of beam tested, mm (in.), and
d=depth of beam tested, mm (in.).

Flexural modulus (tangent modulus of elasticity E_{B} in bending, MPa (psi)) was calculated using the following equation (Eqn. 6 for Tangent Modulus of Elasticity from ASTM D790-17):

$${E}_{B} = \frac{{L}^{3} m}{4 {bd}^{3}}$$

where:
L=support span, mm (in.),
b=width of beam tested, mm (in.),
d=depth of beam tested, mm (in.), and
m=slope of the tangent to the initial straight-line portion of the load-deflection curve, N/mm (lbf/in.) of deflection.

### Preparatory Examples

Preparatory Example PE1

A UV curable binder formulation was prepared using the following steps. 55 g of

EBECRYL 230, 25 g of UX-0937, and 20 g of HEA, 0.3 g of IRGACURE 651, and 0.5 g of IRGACURE TPO-L were added to an amber tinted jar and mixed for 24 hours with gentle rolling.

Preparatory Examples PE2-PE5

UV curing binder formulations PE2-PE5 were prepared in a similar manner as PE1 according to amounts used in grams in Table 1 below.

TABLE 1
Summary of Preparatory Example Formulations

| Prep | | | UX- | | | | | | | | I- | TPO- |
|---|---|---|---|---|---|---|---|---|---|---|---|---|
| Ex. | EB230 | HEA | 0937 | TEGDA | SR494 | t-BA | CN9009 | BD1 | PE1 | TIC | 651 | L |
| PE1 | 55 | 20 | 25 | | | | | | | | 0.3 | 0.5 |
| PE2 | 30 | 20 | 25 | 25 | | | | | | | 0.3 | 0.5 |
| PE3 | 15 | 20 | 15 | 50 | | | | | | | 0.3 | 0.5 |
| PE4 | | | | | 10 | 50 | 40 | | | | | 0.5 |
| PE5 | | | | | | | | 20 | 4 | 15.3 | | 0.2 |

### EXAMPLES

### Example EX1. Metso 20:PE1 (75:25 wt. ratio)

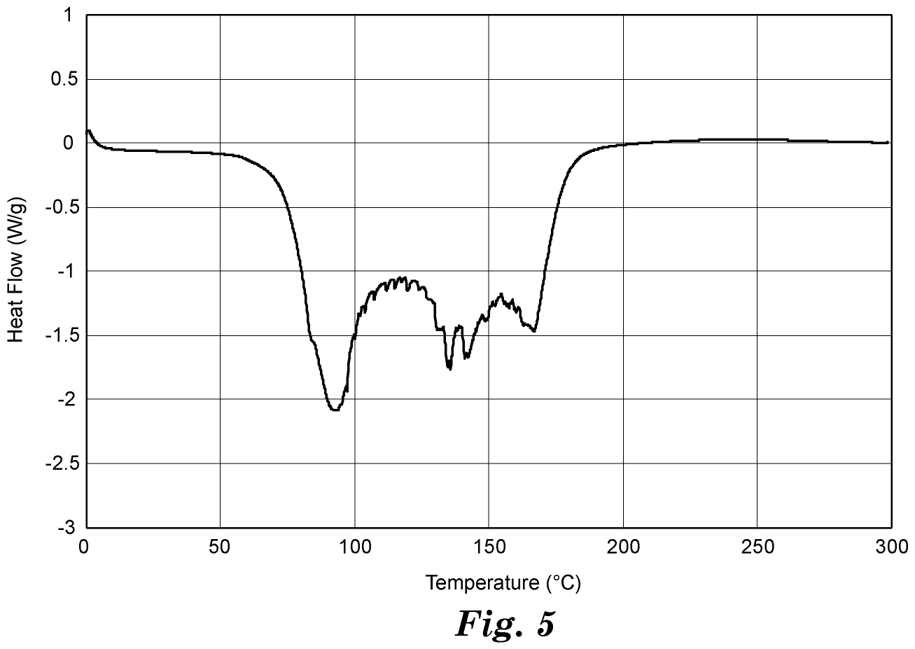

Approximately 7.5 g of Metso 20 was mixed with 2.5 g of PE1 by hand using a wooden spatula for one minute to give an intimate mixture of Metso 20 particles and resin. The mixture was then spread and compacted by hand into a circular 40 mm diameter× 3/16″ deep silicone mold, with any excess mixture being removed to provide a flat, leveled top surface of mixture in the mold. The mixture in the mold was then cured in air using a custom built 380 nm UV LED light source with an output intensity of approximately 60 mW/cm² at a sample-to-light source distance of approximately 4 cm for 5 mins on each face of the sheet sample to produce a flexible, free-standing heat-removing sheet. The DSC analysis of Example EX1 showed 836.3 J/g of heat absorbed between 20 and 240° C. The DSC profile for Example EX1 is shown in FIG. 5. The DSC profile had a peak heat flow rate of −2.08 W/g (i.e., the sample had a heat absorption rate of 2.08 W/g) at a temperature of 91.91° C.

### Example EX2. Metso 20:PE5 (75:25 wt. ratio)

Approximately 18.02 g of Metso 20 was mixed with 5.99 g of PE5 by hand using a wooden spatula for one minute to give an intimate mixture of Metso 20 particles and resin. The mixture was then spread and compacted by hand into a rectangular 4 cm×11 cm× 3/16″ deep silicone mold, with any excess mixture being removed to provide a flat, leveled top surface of mixture in the mold. The mixture in the mold was then cured in air using the UV LED light source from Example EX1 at a sample-to-light source distance of approximately 4 cm for 5 mins on each face of the sheet sample to produce a flexible, free-standing heat-removing sheet. The DSC analysis of Example EX2 showed 816.7 J/g of heat absorbed between 20 and 240° C.

### Examples EX3-EX10 and Comparative Examples CE1-CE4

Examples EX3-EX10 and Comparative Examples CE1-CE4 were prepared in a similar way to EX2: Metso 20 was mixed with either PE1, PE2, PE3 or PE4 in the given weight ratios noted in Table 2 by hand using a wooden spatula for one minute to give an intimate mixture of Metso 20 particles and resin. The mixture was then spread and compacted by hand into a rectangular 0.5 in×3 in×⅛ in deep aluminum mold, with any excess mixture being removed to provide a flat, leveled top surface of mixture in the mold. The mixture in the mold was then cured in air using the UV LED light source from Example EX1 at a sample-to-light source distance of approximately 4 cm for 5 mins on each face of the sheet sample to produce a flexible, free-standing heat-removing sheet. The flexural strength and flexural modulus are reported in Table 2.

TABLE 2
Summary of Examples EX3-EX11 and Comparative Examples
CE1-CE3 Formulations

| | | | | Flex. | Flex. |
|---|---|---|---|---|---|
| | wt % | Prep. Ex | wt % | Strength | Modulus |
| Example | Metso 20 | (PE) | PE | (MPa) | (MPa) |
| EX3 | 70% | PE1 | 30% | 1.87 | 51.9 |
| EX4 | 70% | PE2 | 30% | 3.37 | 127 |
| EX5 | 70% | PE3 | 30% | 3.45 | 207 |
| EX6 | 80% | PE1 | 20% | 0.210 | 5.47 |
| EX7 | 80% | PE2 | 20% | 0.578 | 29.0 |
| EX8 | 80% | PE3 | 20% | 0.268 | 26.2 |
| EX9 | 80% | PE4 | 20% | 0.588 | 183 |
| EX10 | 90% | PE1 | 10% | 0.157 | 6.88 |
| CE1 | 70% | PE4 | 30% | 15.8 | 3029 |
| CE2 | 90% | PE2 | 10% | 0.083 | 5.65 |
| CE3 | 90% | PE3 | 10% | 0.067 | 6.24 |
| CE4 | 95% | PE1 | 5% | 0.040 | 3.38 |

### Example EX11. Metso 20:Imprint 3 LB (80:20 wt. ratio)

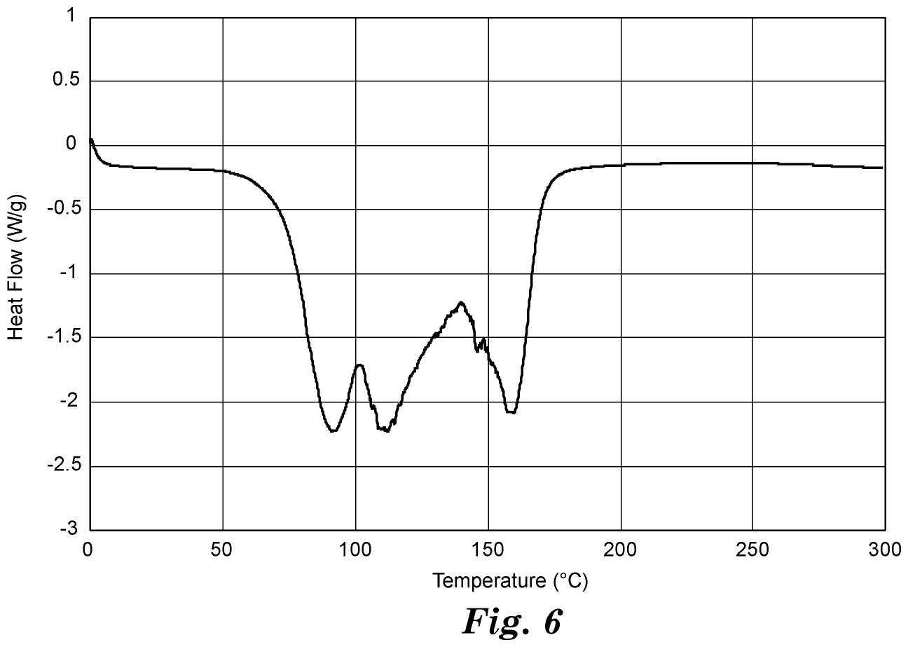

Approximately 17.67 g of Metso 20 was mixed with 2.28 g of yellow paste part from Imp3LB silicone by hand using a wooden spatula for one minute to give an intimate mixture of Metso 20 particles and resin. The particle mixture was then added to 2.14 g of white paste part from Imp3LB silicone and mixed for approximately one minute. The mixture was then spread and compacted by hand into a rectangular 4 cm×11 cm× 3/16″ deep silicone mold, with any excess mixture being removed to provide a flat, leveled top surface of mixture in the mold. The mixture in the mold was then cured at room temperature in air for 30 minutes to produce a flexible, free-standing heat-removing sheet. The DSC analysis of EX11 showed 911.0 J/g of heat absorbed between 20 and 240° C. The DSC profile for Example EX11 is shown in FIG. 6. The DSC profile had a peak heat flow rate of −2.23 W/g (i.e., the sample had a heat absorption rate of 2.23 W/g) at a temperature of 112.0° C.

### Example EX12. Metso 20:RTV (90:10 wt. ratio)

Approximately 10 g of Metso 20 was mixed with 2.85 g of RTV silicone by hand using a wooden spatula for one minute to give an intimate mixture of Metso 20 particles and resin. The mixture was then spread and compacted by hand into a rectangular 4 cm×11 cm× 3/16″ deep silicone mold to fit approximately ½ of the mold volume. The sample was left to cure in air over 3 days at room temperature to produce a flexible, free-standing heat-removing sheet. The DSC analysis of Example EX12 showed 1023 J/g of heat absorbed between 20 to 240° C.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A heat-removing sheet comprising:
a plurality of endothermic particles; and
a chemically cured or radiation cured resin binding the endothermic particles together, wherein the heat-removing sheet includes the endothermic particles at greater than 60 weight percent, has a flexural modulus of less than 3000 MPa and a flexural strength of greater than 0.15 MPa, and
wherein the heat-removing sheet is a single free-standing layer.

2. The heat-removing sheet of claim 1, wherein the heat-removing sheet consists essentially of the chemically cured or radiation cured resin and the endothermic particles.

3. The heat-removing sheet of claim 1, wherein the heat-removing sheet includes the endothermic particles at greater than 80 weight percent.

4. The heat-removing sheet of claim 1, wherein the heat-removing sheet includes the endothermic particles at greater than 60 volume percent.

5. The heat-removing sheet of claim 1 having a flexural modulus of less than 500 MPa.

6. The heat-removing sheet of claim 1 having a flexural strength of greater than 0.5 MPa.

7. The heat-removing sheet of claim 1 having a flexural modulus of less than 200 MPa and a flexural strength of greater than 0.3 MPa.

8. The heat-removing sheet of claim 1, wherein the heat-removing sheet can be bent to an inner radius of curvature of less than 10 cm without yielding or cracking.

9. The heat-removing sheet of claim 1, wherein the plurality of endothermic particles has an endothermic peak temperature in a range of 60° C. to 170° C.

10. The heat-removing sheet of claim 1, wherein the heat-removing sheet has a heat absorption rate of at least 1.8 W/g for at least one temperature in a range of 60° C. to 170° C.

11. The heat-removing sheet of claim 1, wherein the heat-removing sheet absorbs at least 700 J/g when heated from 20° C. to 240° C. at a rate of 10° C./min.

12. The heat-removing sheet of claim 1, wherein the chemically cured or radiation cured resin comprises ultraviolet (UV) cured acrylate.

13. The heat-removing sheet of claim 1, wherein the chemically cured or radiation cured resin comprises chemically cured silicone.

14. The heat-removing sheet of claim 1, wherein the plurality of endothermic particles comprises at least one of a hydrate or a carbonate.

15. A battery comprising a battery cell and the heat-removing sheet of claim 1 disposed adjacent the battery cell.
